(19) United States
(12) Patent Application Publication
(10) Pub. No.: US 2006/0258326 A1
(43) Pub. Date: Nov. 16, 2006

(54) Apparatus For Enhancing The Functionality Of A Digital Device

(76) Inventor: Justin Webb, Aurora, IL (US)

Correspondence Address: GOSNELL & ASSOCIATES, inc.;c/o Intellevate, P.O BOX 52050, MINNEAPOLIS, MN, 55402, US

(21) Appl. No.: 11/383,027

(22) Filed: May 12, 2006

Related U.S. Application Data
(60) Provisional application No. 60/680,171, filed on May 12, 2005.

(51) Int. Cl. H04B 1/08; H04M 1/00

(52) U.S. Cl. 455/350; 455/575.1

(57) ABSTRACT

Various apparatuses and techniques are disclosed for enhancing distribution of sound emitted from a digital device. A spacer or separator provides distance between a speaker on a PDA phone or other digital device and a human ear. The spacer is secured to the digital device with a fastening means, such as adhesive tape or a clip, as a few non-limiting examples. The spacer can be semi-spherical, square, or of numerous other shapes and styles. The spacer helps the user of a PDA phone or other digital device hear a telephone conversation or other sounds more clearly. The spacer also can help keep the user from partially or fully covering up the one or more speakers with the user's ear.

### CROSS-REFERENCE TO RELATED APPLICATION

This application claims the benefit of U.S. Provisional Application No. 60/680,171, filed May 12, 2005, which application is incorporated herein in its entirety.

### BACKGROUND

There are a number of personal digital assistants (PDAs) on the market that also provide the ability to use the PDA as a telephone. A PDA phone typically has a speaker at the top or other section of the device that emits sound, such as conversation from the other party to a telephone call. However, when the user places the device up to his/her ear in order to use the phone feature, his/her ear typically covers over at least part of the speaker, making it difficult to hear the phone conversation clearly. Some efforts to solve this problem have included providing external devices, such as hands free devices, that allow the user to talk on the PDA phone through a portable wired or wireless headset. These hands free kits can be expensive, and often have to be plugged in each time the user wants to use the phone.

The same problem can also occur with other digital devices, such as PDA's without a phone feature, portable music players, etc. Such devices often have speakers that allow a user to listen to sounds being emitted from the device without the use of external headphones. Some of these digital devices also have speakers that are designed in such a way that they are covered in part by the user's ear, thereby obstructing the quality of sound.

### SUMMARY

Various apparatuses and techniques are disclosed for enhancing distribution of sound emitted from a digital device. A spacer or separator provides distance between a speaker on a PDA phone or other digital device and a human ear. The spacer is secured to the digital device with a fastening means, such as adhesive tape or a clip, as a few non-limiting examples. The spacer can be semi-spherical, square, or of numerous other shapes and styles. The spacer helps the user of a PDA phone or other digital device hear a telephone conversation or other sounds more clearly. The spacer also can help keep the user from partially or fully covering up the one or more speakers with the user's ear.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a top elevational view of a prior art PDA phone device.

FIG. 2 is a top elevational view of an apparatus of a first implementation being used with one type of PDA device.

FIG. 3 is a top elevational view of an apparatus of a first implementation.

FIG. 4 is a front elevational view of an apparatus of a first implementation.

FIG. 5 is a back elevational view of an apparatus of a first implementation.

FIG. 6 is a side elevational view of an apparatus of a first implementation.

FIG. 7 is a side perspective view of an apparatus of a first implementation.

FIG. 8 is a top elevational view of an apparatus of a second implementation.

FIG. 9 is a back elevational view of an apparatus of a second implementation.

FIG. 10 is a back elevational view of an apparatus of a third implementation.

FIG. 11 is a side perspective view of an apparatus of the second implementation and third implementation being used with one type of PDA device.

FIG. 12 is a top elevational view of an apparatus of a second implementation and third implementation being used with one type of PDA device.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

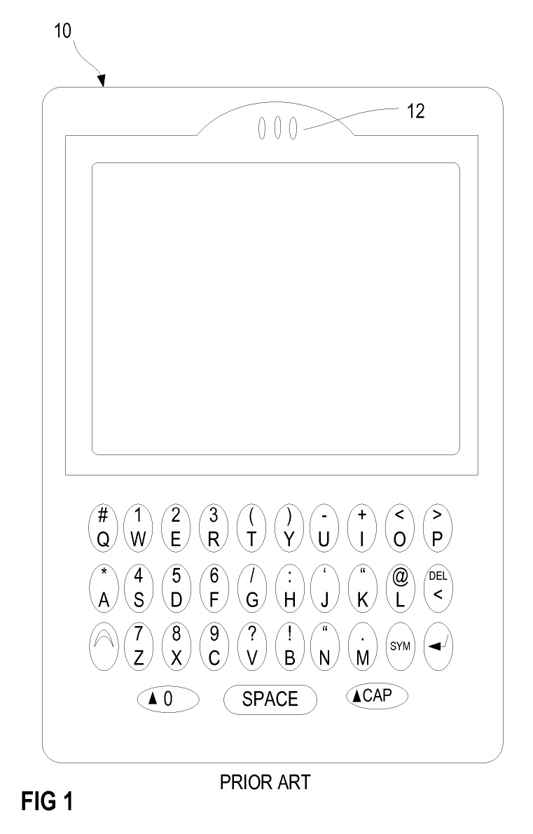

Various technologies and techniques are disclosed for enhancing the distribution of sound emitted from a digital device. In one implementation, an apparatus is disclosed that provides a spacer or separator to provide a distance or clearance between one or more speakers on a digital device and a human ear. Shown in FIG. 1 is one type of PDA phone device 10 with a speaker 12 on the top section of the device. One or more of the apparatuses and/or techniques described herein can be used with a device similar to FIG. 1. However, while the illustrated apparatuses and/or techniques described herein refer to PDA phone device 10, one or more of the apparatuses and/or techniques discussed herein could also be used with various types of digital devices, including smart phones, digital phones, PDA's without phones, portable music devices, and other digital devices, to name a few non-limiting examples. For example, a PDA device may not include a phone, but may still have one or more speakers that are used for purposes such as playing music.

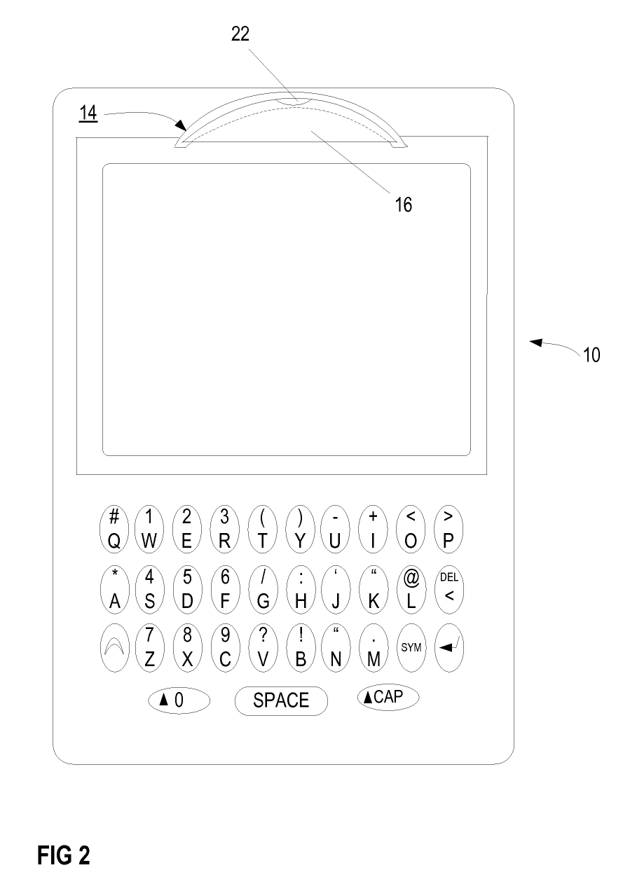

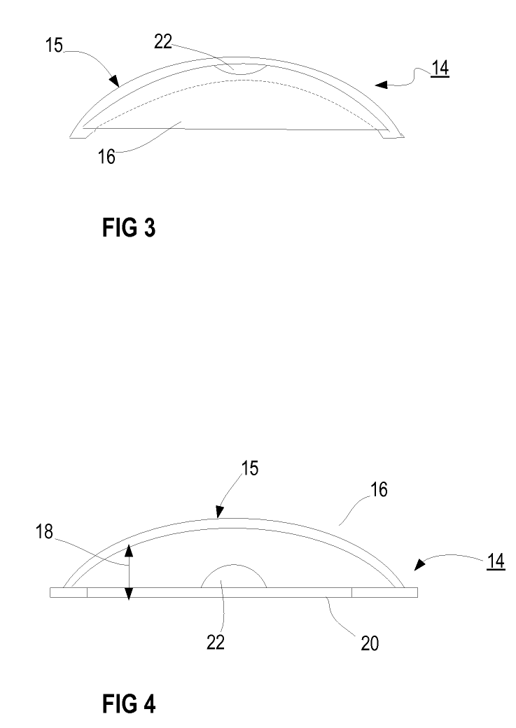

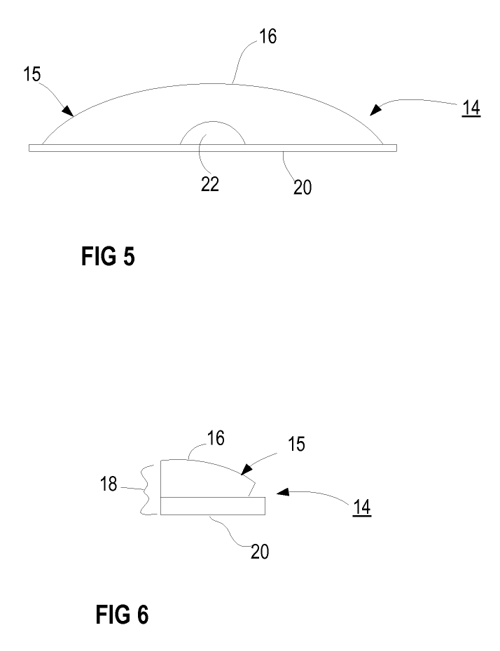

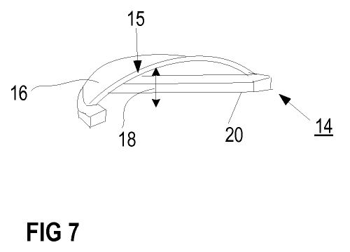

A first implementation of a spacer or separator will now be described with reference to FIGS. 2-7. The same reference numerals will be used to refer to the same elements on the different figures. Shown in FIGS. 2-7 is spacer or separator 14 of one implementation that can be attached to a PDA phone or other digital device 10. Spacer 14 is shown as illustrated comprising an arched member 15 that incorporates a surface 16 on which the user's ear will rest, thereby maintaining distance 18 between one or more speakers 12 and the user's ear. In the implementation illustrated in FIGS. 2-7, spacer 14 is arched or semi-spherical in shape. Spacer 14 can also be made in various other shapes as would occur to one of ordinary skill in the art, including square, or round, to name a few non-limiting examples. Spacer 14 includes a fastening means 20 that is used to fasten spacer 14 to PDA phone 10. Fastening means 20 can be adhesive tape, a clip, or one of various means for securing spacer 14 to PDA phone 10 at a desired location. In one implementation, spacer 14 includes hole 22 in surface 16, such as to facilitate sound travel, while other implementations may not include hole 22.

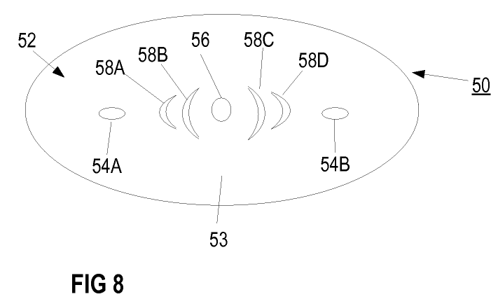

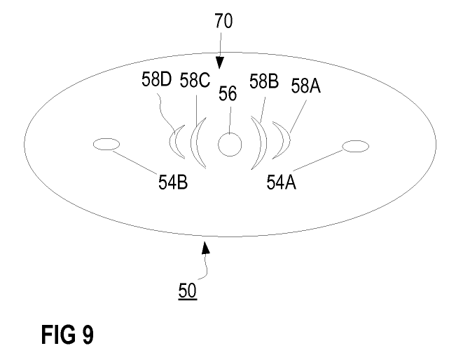

A second implementation of a spacer or separator will now be described with reference to FIGS. 8-9. Again, the same reference numerals will be used to refer to the same elements on the different figures. Shown in FIGS. 8-9 is spacer or separator 50 of a second implementation that can be attached to a PDA phone or other digital device 10. Spacer 50 is shown as illustrated comprising a first side 52 (such as a front side) and a second side 70 (such as a back side). First side 52 incorporates a surface 53 on which the user's ear will rest, thereby maintaining a distance (however slightly) between one or more speakers 12 and the user's ear. In the implementation illustrated in FIGS. 8-9, spacer 50 is flat in shape. Spacer 50 can also be made in various other shapes as would occur to one of ordinary skill in the art, including slightly arched, semi-spherical, square, or round, to name a few non-limiting examples. Spacer 50 includes a fastening means 72 that is used to fasten spacer 50 to PDA phone or digital device 10. In the second implementation shown, fastening means 72 is shown on second side 70. Fastening means 72 can be adhesive, a clip, or one of various means for securing spacer 50 to PDA phone 10 at a desired location. In one implementation, spacer 50 includes one or more holes (54A, 54B, 56, 58A, 58B, 58C, and 58D) in surface 53, such as to facilitate sound travel, while other implementations may include fewer or no holes.

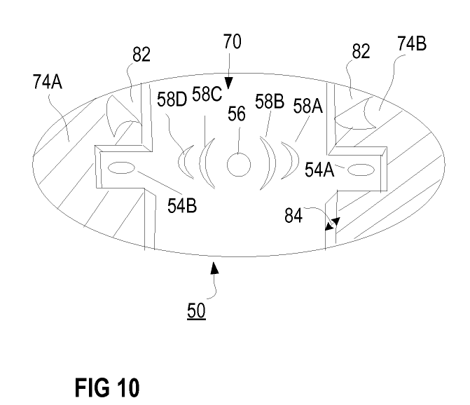

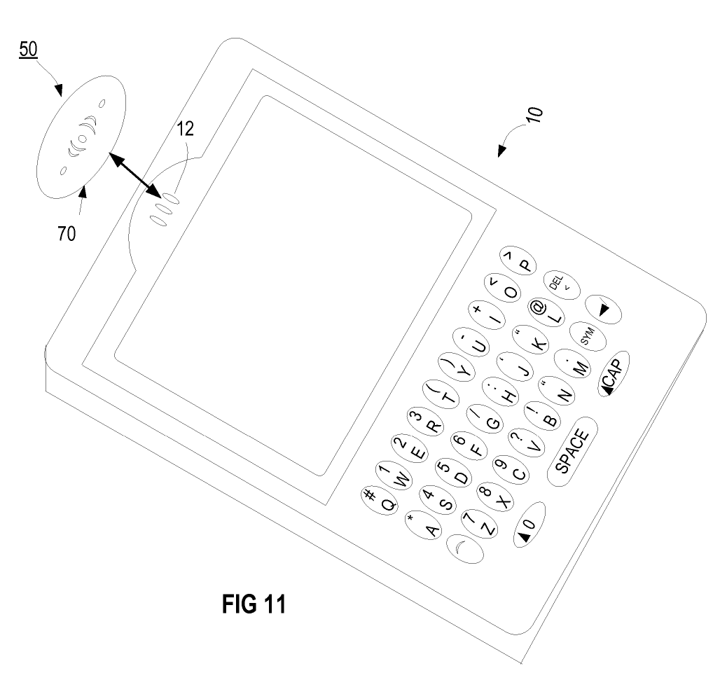

FIG. 10 is a minor variation of the implementation shown in FIGS. 8-9, and includes a fastening means 82 (instead of 72 on FIGS. 8-9) that provides a distance 84 between spacer 50 and speaker(s) 12 when attached to PDA phone or digital device 10. The other features of this implementation are the same as discussed those herein in FIGS. 8 and 9. In one implementation, the distance 84 facilitates sound travel between speaker(s) and a human ear when spacer 10 is attached to PDA phone or digital device 10. In the implementation shown, fastening means 82 is a foam adhesive tape located on two separate ends of spacer 50, and is exposed upon peeling back protective cover 74A and 74B. In other implementations, fastening means 72 can be included in a single area without separation, or in numerous other variations as would occur to one of skill in the art.

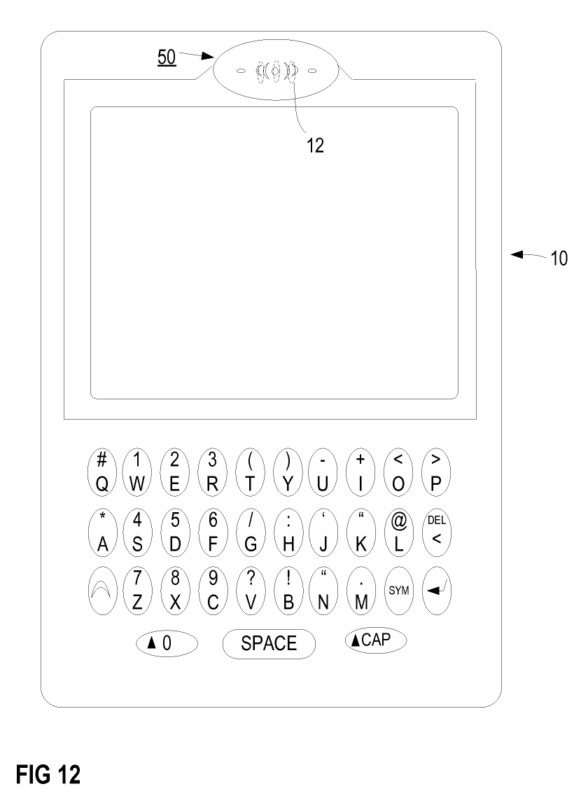

FIGS. 11 and 12 illustrate spacer 50 being applied to PDA phone or digital device 10 for the implementation discussed in FIGS. 8-9 and the implementation discussed in FIG. 10. Second side 70 is lowered so that fastening means (72 on FIG. 9 and 82 on FIG. 10) can be applied to affix spacer 50 to PDA phone or digital device 10 in the area near speaker(s) 12.

One of ordinary skill in the art will appreciate that various other spacer arrangements can be used to maintain a distance and/or provide a separation between the speaker or speakers of a digital device and a human ear.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

What is claimed is:

1. A spacer comprising:
a first side;
a second side, the second side having a fastening means;
at least one hole passing through the first side and the second side;
wherein the first side is operable to allow a human ear to rest at least in part thereon; and
wherein the spacer is operable to facilitate sound travel between a speaker of a digital device and the human ear when the spacer is fastened to the digital device using the fastening means.

2. The spacer of claim 1, wherein the at least one hole is operable to be aligned at least in part with at least one speaker on the digital device when the spacer is fastened to the digital device.

3. The spacer of claim 1, wherein the fastening means is an adhesive tape.

4. The spacer of claim 3, wherein the adhesive tape is operable to provide a distance between the spacer and the digital device when the spacer is fastened to the digital device using the adhesive tape.

5. The spacer of claim 4, wherein the distance provided by the adhesive tape further facilitates sound travel between the speaker of the digital device and the human ear when the spacer is fastened to the digital device using the adhesive tape.

6. The spacer of claim 3, wherein the adhesive tape contains a protective cover that is operable to be peeled back when the user is ready to fasten the spacer to the digital device.

7. The spacer of claim 1, wherein the first side and second side have a flat surface.

8. The spacer of claim 1, wherein the first side and second side have a slightly arched surface.

9. A spacer comprising:
a first member, the first member having a surface on which at least a portion of an ear of a user can rest;
a fastening means, the fastening means being operable to fasten the spacer to a digital device; and
wherein the spacer maintains a distance between at least one speaker of the digital device and the ear of the user when the spacer is fastened to the digital device with the fastening means.

10. The spacer of claim 9, wherein the spacer is operable to facilitate sound travel from the at least one speaker of the digital device to the ear of the user.

11. The spacer of claim 9, wherein the first member is arched in shape.

12. The spacer of claim 9, wherein the first member is semispherical in shape.

13. The spacer of claim 9, wherein the fastening means is an adhesive.

14. The spacer of claim 13, wherein the adhesive is a foam adhesive.

15. The spacer of claim 9, further comprising:
at least one hole.

16. An apparatus comprising:
a spacer;
a fastening means coupled to the spacer;
wherein the spacer is operable to provide a distance between a speaker of a digital device and a human ear when the spacer is fastened to the digital device using the fastening means; and
wherein the spacer is operable to facilitate sound travel between the speaker of the digital device and the human ear.

17. The apparatus of claim 16, further comprising:
at least one hole passing through the spacer.
